(19) United States
(12) Patent Application Publication
(10) Pub. No.: US 2026/0356608 A1
(43) Pub. Date: Nov. 12, 2026

(54) RECEIVING, STORING, AND BLENDING OF PROPPANT

(71) Applicant: Quickthree Tachnology LLC, Yardley, PA (US)

(72) Inventor: Ronald Whelan, Fort Collins, CO (US)

(21) Appl. No.: 19/135,444

(22) PCT Filed: Dec. 5, 2023
(86) PCT No.: PCT/US2023/082424

§ 371 Date: Jun. 4, 2025

Related U.S. Application Data
(60) Provisional application No. 63/386,584, filed on Dec. 8, 2022.

(51) Int. Cl. B65G 65/46; B65G 65/32; E21B 43/26; E21B 43/267

(52) U.S. Cl. CPC B65G 65/46; B65G 65/32; E21B 43/2607; E21B 43/267; B65G 2201/045

(57) ABSTRACT

A system includes a proppant receiving system configured to receive a delivery of proppant from a proppant delivery source and hold the proppant in a proppant storage container, a blender for utilizing proppant to produce a fracking fluid, a blender hopper for the blender, a mechanical conveyor to convey proppant from the proppant storage container to the blender hopper, a silo adjacent to the blender hopper and configured to deliver proppant into the blender hopper via gravity through a silo discharge chute, and a pneumatic conveyor to convey proppant from the proppant storage container into the silo.

### CROSS-REFERENCE TO RELATED APPLICATION(S)

This application claims the benefit of U.S. Provisional Patent Application Ser. No. 63/386,584, filed Dec. 8, 2022, and entitled Receiving, Storing, and Introduction of Proppant to Blender. The disclosure of the prior application is incorporated by reference herein in its entirety.

### FIELD OF THE INVENTION

This application relates to proppant handling and, more particularly, relates to receiving, storing, and introducing proppant into a blender and/or a blender hopper, for example, for blending, at a hydraulic fracturing wellsite.

### BACKGROUND

Hydraulic fracturing (or fracking) refers to a well stimulation technique that involves injecting high-pressure fracking fluid into a wellbore to create cracks in deep-rock formations through which petroleum resources, such as oil or natural gas, can flow. Fracking fluid may vary in composition depending on a variety of considerations and the specific application to which the fracking fluid is to be applied. Fracking fluids, however, typically contain sand or some other proppant that is designed to keep any fractures produced by the fracking process open particularly after the fracking fluid has been withdrawn from the well.

Proppant for fracking is typically delivered to a well site (e.g., near the well head), stored temporarily at the work site, then, at an appropriate time, blended together with other components of the fracking fluid in a blender to form an end product (e.g., fracking fluid with proppant) to be injected into the wellbore.

Demand is high and growing for a reliable and sometimes continuous, or almost continuous, supply of proppant for blending at well sites.

### SUMMARY OF THE INVENTION

A system includes a proppant receiving system configured to receive a delivery of proppant from a proppant delivery source and hold the proppant in a proppant storage container. The system also includes a blender that utilizes the proppant to produce a fracking fluid. The blender has a blender hopper that provides a supply of proppant to the blender. A mechanical conveyor is configured to convey the proppant from the proppant storage container to the blender hopper. One or more silos are adjacent to the blender hopper and configured to deliver proppant into the blender hopper (e.g., via gravity) through silo discharge chutes. A pneumatic conveyor is configured to convey proppant from the proppant storage container into any one or more of the silos.

In some implementations, one or more of the following advantages are present.

For example, implementations of the systems and techniques disclosed herein ensure large amounts of proppant will be readily available at a wellsite, regardless of whether demand is steady and high or fluctuating. The systems and techniques typically provide for significant redundancy and are robust, yet flexible. The systems are easy to maintain, relatively inexpensive, and straightforward.

Other features and advantages will be apparent from the description and drawings, and from the claims.

### BRIEF DESCRIPTION OF THE DRAWINGS

FIG. 1 is a side view of an exemplary implementation of a wellsite proppant handling and blending system.

FIG. 2 is a top view of the exemplary implementation of the wellsite proppant handling and blending system of FIG. 1.

FIG. 3 is a first perspective view of the exemplary implementation of the wellsite proppant handling and blending system of FIG. 1.

FIG. 4 is a first end view of the exemplary implementation of the wellsite proppant handling and blending system of FIG. 1.

FIG. 5 is a second end view of the exemplary implementation of the wellsite proppant handling and blending system of FIG. 1.

FIG. 6 is a second perspective view of the wellsite proppant handling and blending system of FIG. 1.

FIG. 7 is a partial cross-sectional, side view of an exemplary implementation of a mechanical conveyor.

FIG. 8 is a cross-sectional view of the loading area of the mechanical conveyor of FIG. 7.

FIG. 9 is a cross-sectional view of the inclined section of the mechanical conveyor of FIG. 7.

FIG. 10 is a perspective view of an exemplary implementation of a mechanical conveyor with a partial view of a blender hopper.

FIG. 11 is a perspective view of an alternative exemplary implementation of a mechanical conveyor with a partial view of blender hoppers.

FIG. 12 is a partial perspective view of yet another exemplary implementation of a mechanical conveyor.

FIG. 13 is a side view of an exemplary implementation of a proppant receiver.

FIG. 14 is a detail view showing part of the proppant receiver of FIG. 13.

FIG. 15 is an internal, schematic representation showing an example of a component arrangement inside of a blender hopper.

Like reference characters refer to like elements.

### DETAILED DESCRIPTION

Hydraulic fracturing (or fracking) refers to a well stimulation technique that involves injecting high-pressure fracking fluid into a wellbore to create cracks in deep-rock formations through which petroleum resources, such as oil or natural gas, can flow. Fracking fluid may vary in composition depending on a variety of considerations and the specific application to which the fracking fluid is to be applied. Fracking fluids, however, typically contain sand or some other proppant that is designed to keep any fractures produced by the fracking process open particularly after the fracking fluid has been withdrawn from the well. Proppant for fracking may be delivered to a well site (e.g., near the well head), stored temporarily at the work site, then, at an appropriate time, blended together with other components of the fracking fluid to form an end product (e.g., fracking fluid, which contains proppant) to be injected into the wellbore. Demand is high and growing for a reliable and at times continuous or almost continuous supply of proppant for blending at well sites. In various implementations, the systems and techniques disclosed herein facilitate satisfying that demand.

In a typical implementation, the systems and techniques disclosed herein provide for high capacity storage of proppant at (or near) the well head of a fracking operation in a manner that ensures the proppant is readily available for delivery into a blender. This helps meet the high and growing demand for proppant. It is also important because delivery of proppant, at times, can be unreliable or irregular. Therefore, having high on-site storage capability, as provided by a typical implementation of the systems disclosed herein, can be important.

For example, typically, trucks deliver proppant to well sites. Each truck may pull into the well site, deliver its load of proppant (e.g., via gravity dump or some other conveying technique) into a proppant receiver (i.e., a system, such as the SmartPath™ unloading system, available from Smart Sand, Inc., the applicant on the current application) that is configured to receive and store deliveries of proppant from trucks) at the wellsite, then drives off. It is often desirable that, as one emptied truck pulls away from the proppant receiver, another loaded truck pulls up immediately to the proppant receiver and delivers its load of proppant into the proppant receiver. This process may be repeated over and over again, with each delivery truck dropping off its load of proppant almost immediately (e.g., without any deliberate delay) after the prior delivery has been completed. Given the frequent high demand for proppant at well sites, it is not unusual for multiple trucks to be lined up, in a queue, ready to deliver their loads of proppant into a proppant unloading system, with each truck pulling into the delivery station as the prior truck pulls out. This can help ensure a relatively steady and high rate of proppant delivery to the well site to help to satisfy the demand for proppant. In a typical implementation, the systems and techniques disclosed herein are capable of receiving and accommodating a high rate of proppant delivery to a well-site.

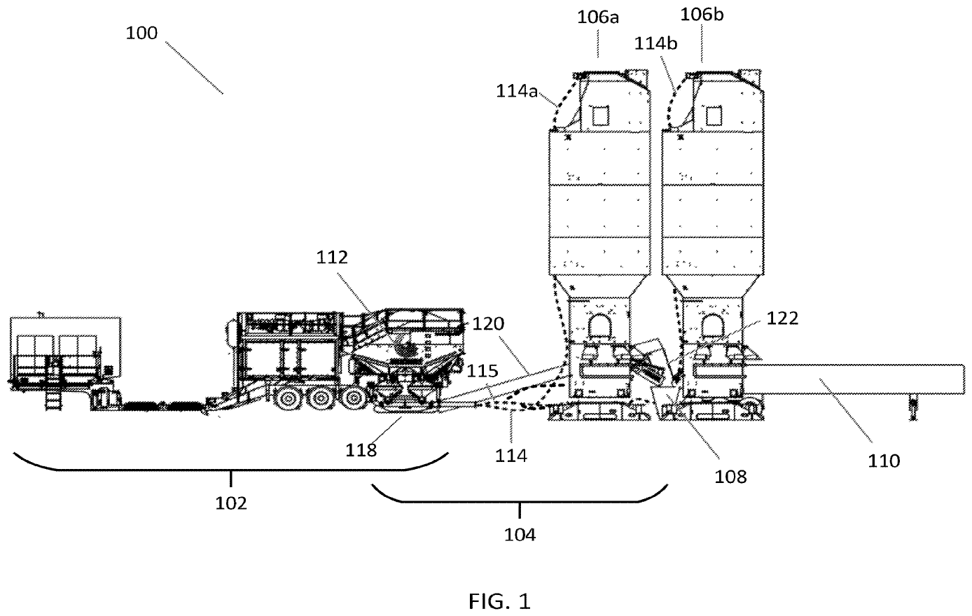

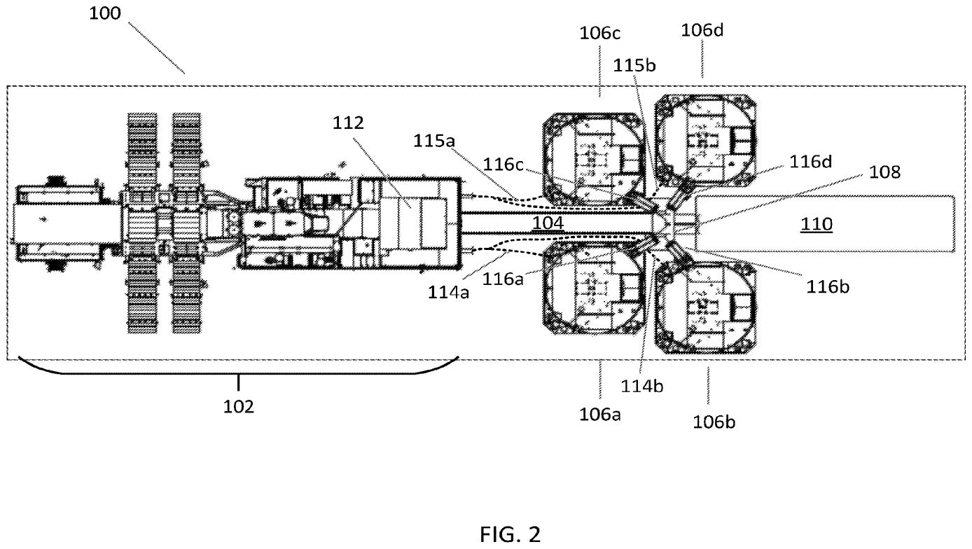

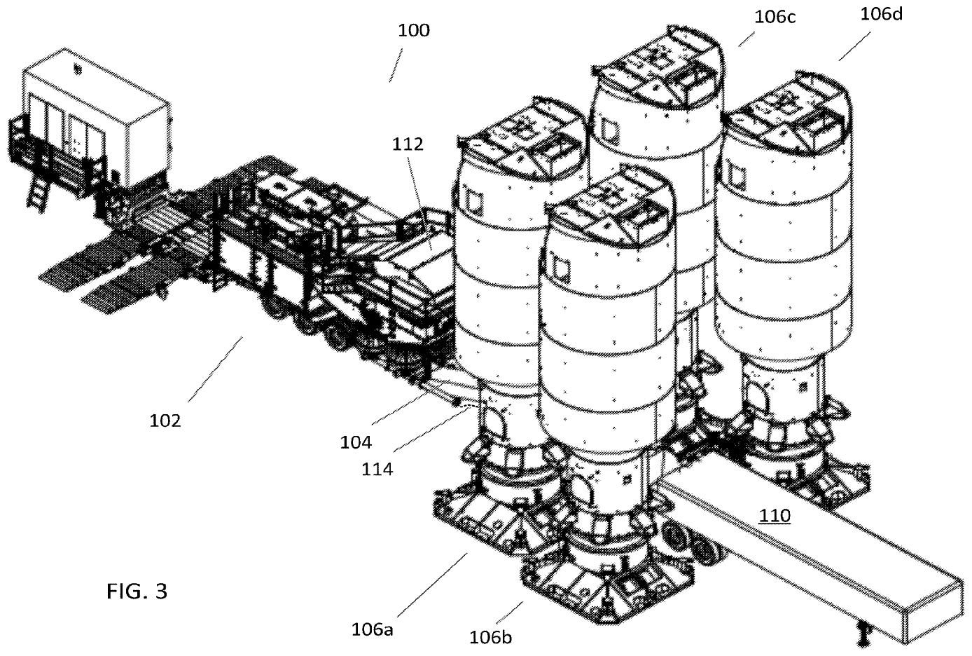

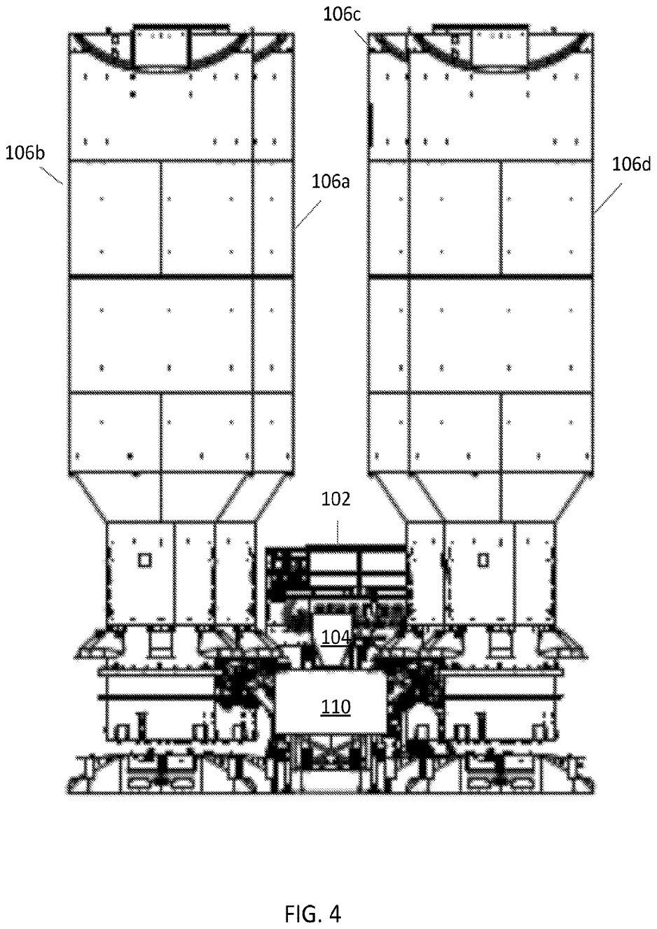

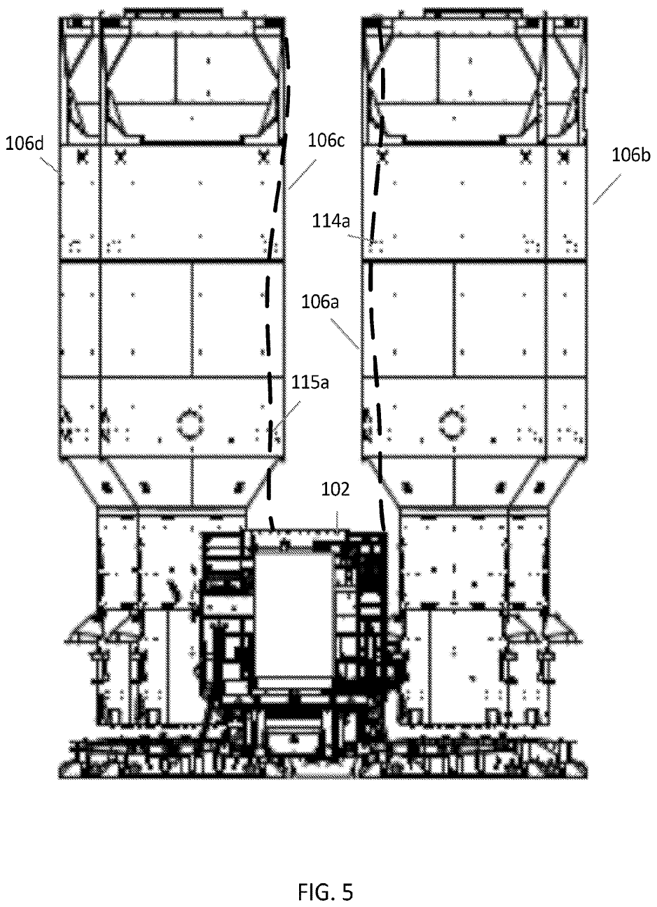

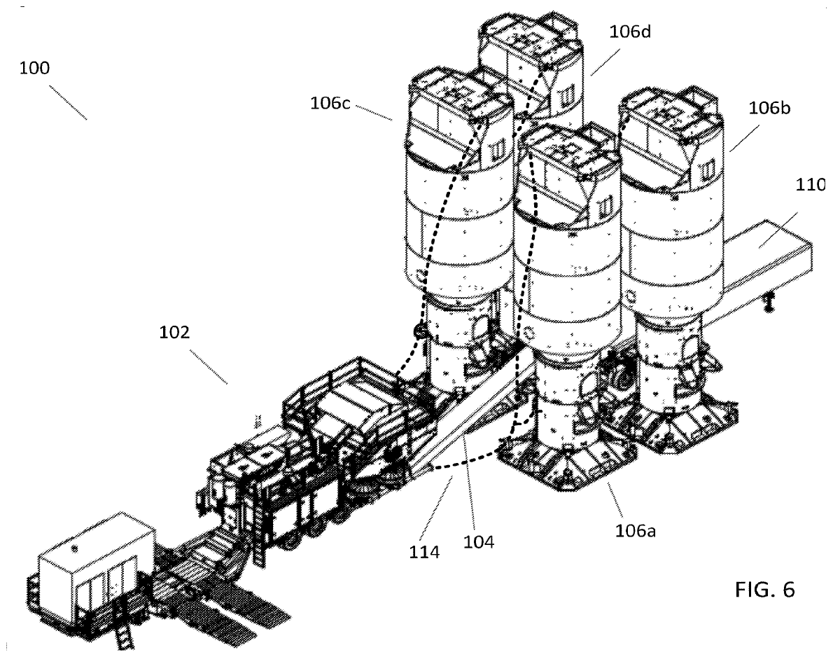

Numerous obstacles can make it difficult for truck drivers to reach their intended well site destinations at desired times. These obstacles can include, for example, traffic conditions, mechanical failures, physical limitations of the drivers, challenges with loading trucks with proppant for delivery, and/or legal restrictions (restricting, e.g., where and when trucks might be allowed to drive). With a typical implementation of the systems and techniques disclosed herein, disruptions in proppant delivery can be easily managed because the system can store large amounts of proppant on-site in a convenient manner. As an example, a system, such as the one represented in FIGS. 1-6, may include, at any point in time, a fully (or significantly, e.g., 80% or more) loaded proppant storage tank on the proppant receiving system, multiple (e.g., four or potentially more) silos, and a proppant blender hopper-all containing proppant that can support fracking operations.

Moreover, typically, the systems disclosed herein for receiving and storing proppant so that the proppant is readily available for introduction into a blender at a well site are robust and, as a result, highly reliable. Unplanned downtime or interruptions in a system for receiving and storing proppant at a well site for delivery into a blender, particularly at a busy well site, can be very costly. Robust and reliable systems and components, especially when properly maintained, can help avoid or at least minimize unplanned downtime or interruptions and, thereby further support the aim of the meeting the high and growing demand for proppant at well sites.

Additionally, typically, the systems and techniques disclosed herein facilitate the automatic adjustment of proppant delivery rate into the blender hopper of a well site blender to match requirements of the blender, which can and sometimes do vary. These automatic adjustments are done without the intervention of a human operator, which helps reduce overall operational costs for the system as well as reducing propensity for error.

Typically, the systems disclosed herein are relatively simple in terms of construction and operation, which contributes to low cost and requirements for human operator intervention. System maintenance also is very straightforward and easy to do. Moreover, the systems may be deployed in a compact manner having an overall footprint that is small, particularly given the various functionalities, storage capacity, and operational and cost advantages of the system.

Of course, many other advantages may be present as well.

FIGS. 1-6 show an exemplary implementation of a system 100 for receiving and storing proppant in a manner that makes the proppant readily available for introduction into a blender hopper 108 of an onsite blender unit 110. The blender unit 110 is configured to blend the proppant with a liquid (e.g., water, etc.) to produce fracking fluid for delivery into a wellbore (typically adjacent to the illustrated system 100) to support fracking operations. The system 100 includes a proppant receiver 102, a plurality of silos 106a-106d, and a mechanical conveyor 104. The proppant receiver 102 is configured to receive deliveries of proppant from delivery trucks that drive over the proppant receiver 102 and dump their deliveries, typically via gravity, and then hold the proppant, at least temporarily, in a proppant storage tank 112 on the proppant receiver 102.

The proppant receiver 102 has provisions for conveying proppant from the proppant storage tank 112 to: A) one or more of the silos 106a-106d, pneumatically, via one or more pneumatic conveying lines 114, 115, and/or B) the blender hopper 108 by gravity dumping proppant from the proppant storage tank 112 and onto the mechanical conveyor 104, which is configured to deliver the dumped proppant, via the mechanical conveyor 104, to the blender hopper 108. Each silo 106a-106d has a discharge chute 116a-116d, through which proppant can flow, under the influence of gravity, into the blender hopper 108. The blender hopper 108 in the illustrated system 100, therefore, is configured to receive proppant via any one or more multiple supply routes through the system 100, including from the mechanical conveyor 104 (which receives proppant via gravity drop from the proppant storage container 112 on the proppant receiver 102), and/or from any one or more of the silos 106a-106d (which receive proppant via pneumatic conveying lines 114, 115 from the proppant storage container 112 on the proppant receiver 102). In some instances, the system 100 may be operated such that the mechanical conveyor 104 is the primary supplier of proppant to the blender hopper 108 and the silos 106a-106d act as backup or standby proppant supply sources for the blender hopper 108 (e.g., in the event that the supply of proppant from the mechanical conveyor 104 becomes unavailable).

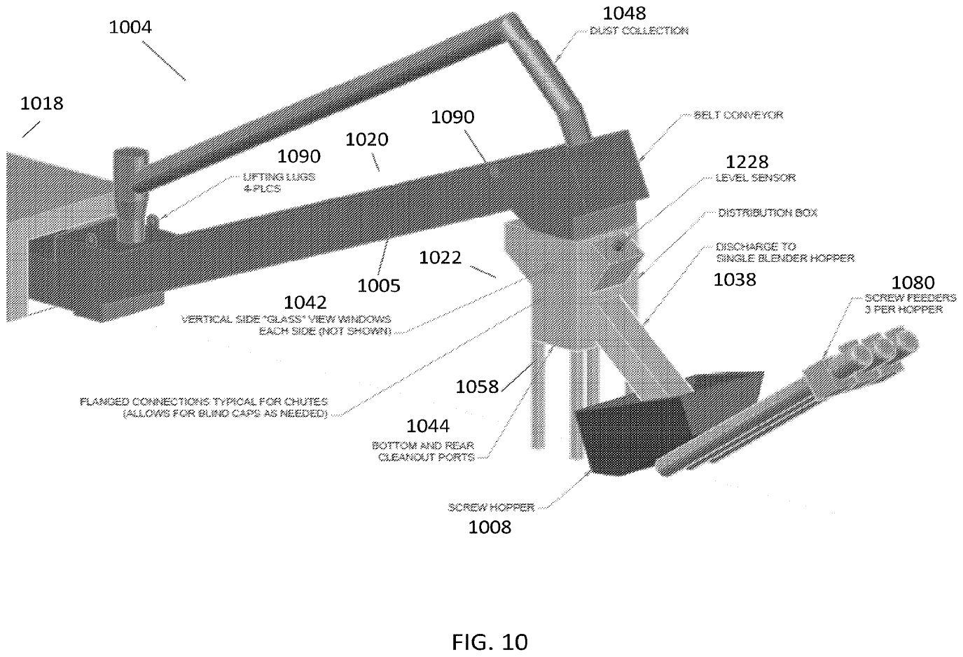

Typically, if the mechanical conveyor 104 is acting as the primary supplier of proppant to the blender hopper 108, the mechanical conveyor 104 supplies most, if not all, the proppant needed to support fracking operations at the well into the blender hopper 108. The proppant may be supplied at a steady rate or at a variable rate depending upon system demand, for example. The proppant supplied by the mechanical conveyor 104, for example, may help replenish any proppant that gets drawn out of the blender hopper 108, for example, into the blender 110 (e.g., by one or more screw conveyors, not shown in FIGS. 1-6, but see 1080 in FIG. 10). This helps maintain a supply of proppant in the blender hopper 108 at all times, even as proppant is being drawn out of the blender hopper 108.

While the mechanical conveyor 104 is acting as the primary supplier of proppant into the blender hopper 108, the one or more silos 106a-106d standby and act as a backup proppant supply source to the blender hopper 108 available, for example, if the mechanical conveyor 104 ceases to provide an adequate supply of proppant into the blender hopper 108 to support well fracking operations.

Typically, the discharge chutes 116a-116d of the silos 106a-106d are positioned relative to the blender hopper 108 such that, when the level of proppant inside the blender hopper 108 is sufficiently high, the proppant inside the blender hopper 108 chokes off the discharge chutes 116a-116d of the silos 106a-106d to prevent the flow of proppant through the discharge chutes 116a-116d until and unless the level of proppant drops below a threshold level. If and when the level of proppant inside the blender hopper 108 drops below the threshold level, one or more of the discharge chutes 116a-116d become unblocked thereby allowing the flow of proppant through the unblocked discharge chute(s). Thus, the discharge chute 116a-116d of a particular silo 106a-106d is and remains choked off if, and for as long as, the proppant in the blender hopper 108 is at a sufficiently high level and static so as to prevent flow of proppant through that discharge chute 116a-116d. In this choked off state, the choked off silo will not supply any proppant into the blender hopper 108 through its discharge chute 116a-116d unless and until the level of proppant at the discharge opening of the choked off discharge chute 116a-116d starts to drop (e.g., below the threshold level of the discharge opening of the discharge chute 116a-116d) thereby allowing flow to start. Flow is prevented in a choked off discharge chute 116a-116d even if though any valve on the silo's discharge chute 116a-116d may be in an open position and otherwise permitting proppant to flow through the discharge chute 116a-116d. In normal system 100 operation, any valves on or for the silo discharge chutes are and remain in an open position while the system 100 is in operation.

Thus, any silos 106a-106d acting as a backup or standby proppant supply source for the blender hopper 108 may contain static proppant in its discharge chute 116a-116d but none of that proppant would be flowing through the discharge chute 116a-116d until and unless needed. If the level of proppant starts to drop in the blender hopper 108 near or below the discharge opening of the discharge chute 116a-116d (e.g., the threshold level), then proppant would automatically begin to flow through discharge chute 116a-116d under the influence of gravity. This may happen, for example, if the mechanical conveyor 104 for some reason stops supplying enough proppant into the blender hopper 108 to adequately replenish the proppant being drawn out of the blender hopper 108. The proppant typically continues to flow until the proppant in the blender hopper 108 rises to a sufficient level to once again block and choke off flow through the discharge chute. At this point, the mechanical conveyor 104 may again start supplying proppant to replenish any proppant being removed from the blender hopper 108. As long as the mechanical conveyor 104 continues to supply enough proppant to replenish the proppant being removed from the blender hopper 108, the proppant level in the blender hopper 108 near the discharge chutes of the silos 106a-106d remains high enough to continue choking off flow through the silo discharge chute(s).

The mechanical conveyor 104 in FIGS. 1-6 are configured to deliver (e.g., drop) proppant into the blender hopper 108 via a drop chute. The drop chute 122 of the mechanical conveyor 104 in FIGS. 1-6 extends down and into the blender hopper 108, such that its distal end of the drop chute 122 is inside the blender hopper 108. In various implementations, the distal end of the drop chute 122 may not extend down into the blender hopper 108, but instead will be positioned above the blender hopper 108 so that a level of proppant inside the blender hopper would. With the drop chute 122 so configured, the discharge opening at a distal end of the drop chute 122 is below (or at least near and above) the upper rim of the blender hopper 108. Moreover, often, the discharge opening of the drop chute 122 is close to the inputs of the conveyor(s) (e.g., screw conveyors) provided to convey proppant out of the blender hopper 108 and into the blender 110. In various implementations, the discharge opening of the drop chute 122 may be within 18 inches, 12 inches, 6 inches, 3 inches, or closer of the input of such conveyor (that conveys proppant out of the blender hopper 108).

The conveyor(s) that convey the proppant out of blender hopper 108 and into the blender 110 can have any one of a variety of different physical configurations. In some implementations, the conveyor(s) may be screw conveyor(s). A screw conveyor (or auger conveyor) is a mechanism that uses a rotating helical screw blade, usually within a tube or trough, to move a material (e.g., proppant). The screw conveyors may be disposed at a slight incline and arranged parallel to one another. The helical screw blade may be coiled around a shaft, driven at one end (e.g., by an electric motor) and held at the other, or may be a shaftless spiral, driven at one end (e.g., by an electric motor) and free at the other. The rate of proppant transfer out of the blender hopper 108 by a screw conveyor is generally proportional to the rotation rate of the shaft or screw. Where multiple conveyors are provided to convey proppant out of the blender hopper 108, the conveyors may be arranged parallel to one another. Moreover, the discharge opening of the drop chute 122 may be configured and positioned to distribute proppant across the inputs of the multiple conveyors to facilitate a steady supply of proppant to all of the multiple conveyors.

The silos 106a-106d in FIGS. 1-6 are positioned adjacent to and surrounding the blender hopper 108. Each silo 106a-106d has a discharge chute 116a-116d that extends in an outward and downward direction from a lower portion of a side wall of the silo 106a-106d. Each discharge chute 116a-116d defines an internal flow path for proppant to flow out of the silo under the influence of gravity when the flow path is unobstructed (e.g., when a discharge valve in the discharge chute is open and the flow path is not otherwise blocked by static proppant backed up in the blender hopper 108). A discharge opening is at the end of each internal flow path and at a distal end of each discharge chute 116a-116d.

The discharge chutes 116a-116d of the silos 106a-106d are shown in FIGS. 1-6 as being directed inward towards the blender hopper 108. Each discharge chute 116a-116d in FIGS. 1-6 however is shown entirely above the blender hopper 108. Prior to system operations, the discharge chutes 116a-116d may be lowered into the blender hopper 108 such that their discharge openings at the distal ends thereof are inside the blender hopper 108 (e.g., below the upper rim of the blender hopper 108).

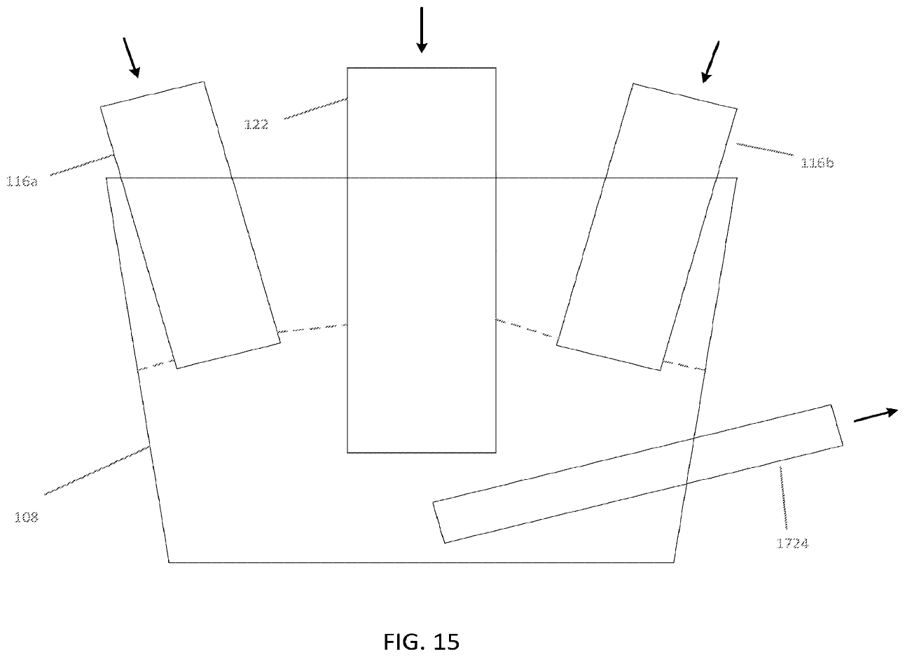

FIG. 15 is an internal, schematic representation showing an example of a component arrangement inside of blender hopper 108. The illustrated components include the drop chute 122 of the mechanical conveyor 104, the discharge chutes 116a, 116b of the silos 106a, 106b, and a screw conveyor 1724. As represented by the arrows in the figure, the drop chute 122 of the mechanical conveyor 104 and the discharge chutes 116a, 116b of the silos 106a, 106b introduce proppant into the blender hopper 108 and the screw conveyor 1724 transfers proppant from the blender hopper 108 to the blender 110.

The drop chute 122 of the mechanical conveyor 104 and the discharge chutes 116a, 116b of silos 106a, 106b extend through the open top of and down into the blender hopper 108. The discharge opening at the bottom, distal end of the drop chute 122 and the discharge openings at the bottom, distal ends of the discharge chutes 116a, 116b are below the top (e.g., the upper rim) 1726 of the blender hopper 108. Moreover, the drop chute 122 of the mechanical conveyor 104 extends deeper into the blender hopper 108 than the discharge chutes 116a, 116b of the silos 106a, 106b. Thus, the discharge opening at the bottom, distal end of the drop chute 122 sits lower inside the blender hopper 108 than the discharge openings at the bottom, distal ends of the discharge chutes 116a, 116b. Moreover, the distance between the discharge opening at the bottom, distal end of the drop chute 122 and the inlet of the screw conveyor 1724 is smaller than the distance between the discharge openings at the bottom, distal ends of the discharge chutes 116a, 116b and the inlet of the screw conveyor 1724. In some implementations, such as the one schematically represented in the figure, the drop chute 122 is directly above the inlet of the screw conveyor 1724 in the blender hopper 108, and surrounded by the discharge chutes (e.g., 116a-116d) from the silos (e.g., 106a-106d).

If the level of proppant in the blender hopper 108 is at the dashed line in FIG. 15 or above and the discharge chutes 116a, 116b are full of proppant, then the discharge chutes 116a, 116b would be choked off by the proppant and flow would not occur through the discharge chutes 116a, 116b. This choked off condition would persist until and unless the level of proppant in the blender hopper 108 dropped below the discharge openings of the discharge chute 116a, 116b. Meanwhile, as long as the proppant level remained sufficient to choke off the silo discharge chutes 116a, 116b (e.g., at the dashed line level), the mechanical conveyor 104 would operate to replenish the proppant (e.g., through the drop chute 122 near the input of the screw conveyor 1724) as the screw conveyor 1724 pulls proppant out of the blender hopper 108.

In a typical implementation, the system 100 automatically adjusts the speed of the mechanical conveyor 104 to maintain a sufficient flow of proppant into the blender hopper 108 to offset any proppant being pulled out of the blender hopper 108 by the screw conveyor 1724. Thus, in a typical implementation, if the screw conveyor 1724 speeds up to draw proppant out of the blender hopper 1724 at a higher rate, the mechanical conveyor 104 may automatically speed up as well to increase the rate of proppant delivery into the blender hopper 1724. Similarly, if the screw conveyor 1724 slows down and decreases the rate at which proppant is drawn out of the blender hopper 1724, the mechanical conveyor 104 may automatically slow down to decrease the rate of proppant delivery into the blender hopper 1724.

In a typical implementation, the system 100 may include a level sensor (not shown in FIGS. 1-6 or 17 but see 1228 in FIG. 10) integrated into the drop chute 122 of the mechanical conveyor 104 to sense a level of proppant (e.g., inside the drop chute 122 or inside the drop chute 122 and the blender hopper 108). In such implementations, the level sensor 1228 communicates with a controller and the controller regulates the speed of the mechanical conveyor 104 in response to sensor readings from the level sensor 1228. More specifically, in a typical implementation, the controller increases the speed of the mechanical conveyor 104 in response to sensor reading(s) indicating that the proppant level in the drop chute 122 has been (or is) dropping and/or decreases the speed of the mechanical conveyor 104 in response to sensor reading(s) indicating that the proppant level in the drop chute 122 has been (or is) rising. In some implementations, the controller may control the speed of the mechanical conveyor 104 so that the speed of the mechanical conveyor 104 is inversely proportional to the level of proppant sensed by the level sensor 1228.

Moreover, in some implementations, the controller automatically stops the mechanical conveyor 104 if the level sensor signal indicates that the proppant level has risen to a predetermined stopping level. If that happens, typically, the controller will automatically restart the mechanical conveyor 104 if the proppant level subsequently drops below a predetermined restarting level. Typically, the predetermined restarting level will be lower than the predetermined stopping level. Moreover, typically, the predetermined stopping level and the predetermined restarting level may be represented by data stored (e.g., in a computer memory within or accessible from the controller).

In view of the foregoing, it can be seen that, the mechanical conveyor 104 typically delivers most of the needed proppant into the blender hopper 108 and the silos 106a-106d provide an automatic back-up to the mechanical conveyor 104, if needed. The silos 106a-106d can be refilled with proppant, as needed, from the proppant storage container 112 via the pneumatic lines 114, 115. In some implementations, the refilling can be done manually. In some implementations, the refilling can be automatic. In implementations, where the refilling is done automatically, the silos 106a-106d may be equipped with level sensors and the levels sensors that sense proppant levels inside the silos 106a-106d. In such implementations, the silo level sensors may communicate with a controller (e.g., the same controller mentioned above). If the controller receives a sensor signal from the silo level sensor indicating that the proppant level in that silo has dropped below a predetermined level, the controller may activate the pneumatic conveying system from the proppant storage container 112 to one or more of the silos 106a-106d. Activating the pneumatic conveyor may include, for example, opening a flow path (e.g., by opening a valve) from the proppant storage container 112, through an air lock, and into one or more of the pneumatic lines 114, 115, turning on the air source (e.g., a fan or air compressor on the proppant receiver 102), and controlling any other valving required to direct the conveyed proppant into the appropriate silo(s). Once activated, the pneumatic conveyor conveyors proppant into one or more of the silos. Meanwhile, the level sensors continue to monitor proppant levels in the silos. When the controller receives level sensor signal(s) indicating that the silo(s) being filled has reached a predetermined level of proppant, the controller ceases operation of the pneumatic conveyor. Ceasing operation of the pneumatic conveyor may entail closing any valves that previously were opened and turning off the air source. The predetermined silo proppant level for activating the pneumatic conveyor would be lower than the predetermined silo proppant level for ceasing operation of the pneumatic conveyor. In any event, each of these predetermined levels may be represented by data stored (e.g., in a computer memory within or accessible from the controller).

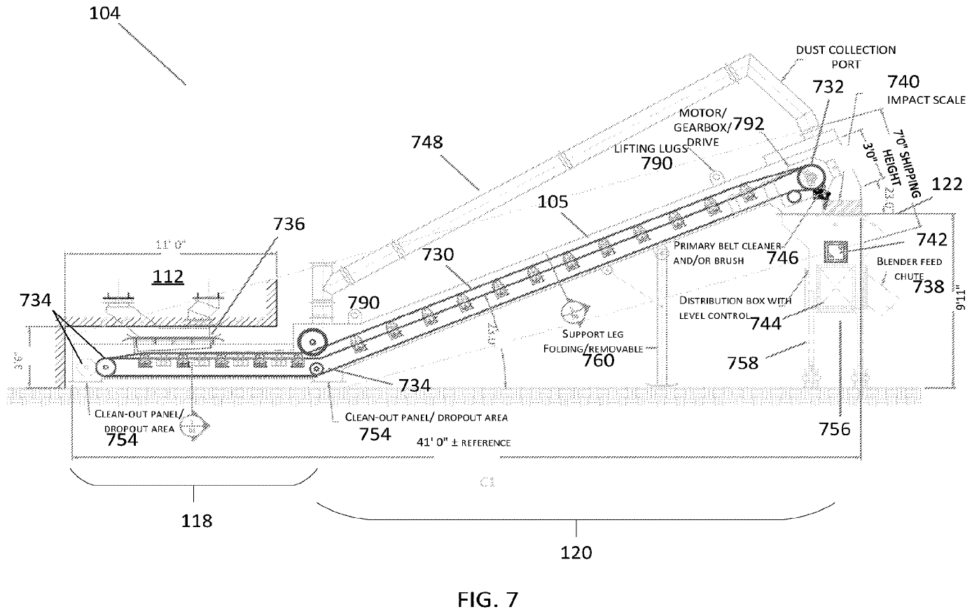

FIGS. 7, 8, and 9 are views of an exemplary implementation of mechanical conveyor 104, which, when incorporated into the system 100 of FIGS. 1-6, is configured to receive proppant that is dropped from the proppant storage tank 112 and mechanically convey that proppant up to and into the blender hopper 108 of the blending unit 110.

The mechanical conveyor 104 includes the first section 118 that is horizontal and configured to sit beneath a gravity drop of the proppant storage tank 112, the second section 120 that extends at an upward angle from an end of the first section 118, and the third section 122 (i.e., the drop chute section) that extends downward from an end of the second section 120 to a discharge chute 738 (the blender feed chute) at the distal end of the mechanical conveyor 104.

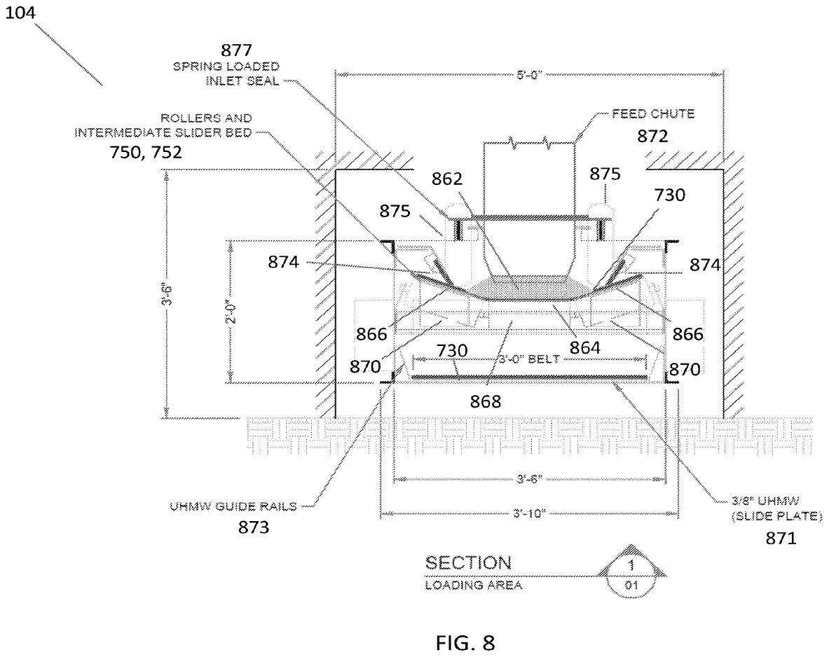

The mechanical conveyor 104 has a housing 105. The housing 105, in the first section 118 and the second section 120 of the mechanical conveyor 104, contains a belt conveyor system. A belt conveyor system generally consists of two or more pulleys, with a closed loop of carrying medium (i.e., a conveyor belt) that rotates about them. One or both of the pulleys are powered (e.g., by an electric motor 792 (with a gear box) or some other prime mover) that moves the belt and the material on the belt forward. Any powered pulleys may be referred to as drive pulleys, while any unpowered pulleys may be referred to as idler pulleys. The belt conveyor in FIG. 7 includes a conveyor belt 730 coupled to a drive pulley 732 and several idler pulleys (e.g., 734). Rollers 750 and (optional) intermediate slider beds 752 (see, e.g., FIG. 8) support the belt 730 between pulleys. The conveyor belt 730 has a first horizontal section that corresponds to the first section 118 of the mechanical conveyor 104, and a second inclined section that corresponds to the second section 120 of the mechanical conveyor 104.

During operation, proppant is dropped onto the belt 730 through an opening in the housing 105 (at 736) and is carried by the belt 730 on the first, horizontal section of the belt and then up the second, inclined section of the belt 730. The proppant is then dropped off the upper end of the second, inclined section of the belt 730 into the drop chute 122 and then to the blender hopper 108 through the blender feed chute 738 portion of the drop chute 122. The blender feed chute 738 portion of the drop chute 122 extends at a downward and frontward angle from the rest of the drop chute 122. In a typical implementation, as discussed above, the blender feed chute 738 would be positioned to extend into the blender hopper 108 so that the discharge opening (e.g., at the distal end of the blender feed chute 738) is positioned well below the upper rim of the blender hopper 108 and near the conveyor(s) that are conveying proppant out of the blender hopper 108.

The drop chute 122 portion of the housing 105 contains an impact scale 740 just under the top front end of the belt conveyor system. The drop chute 122 may be operable to provide a measure representing weight and/or flow rate of proppant through the mechanical conveyor 104. The impact scale 740 can have any one of a variety of different physical configurations. In a typical implementation, the impact scale 740 works by measuring the horizontal force only from the free falling proppant dropped off the top front end of the belt conveyor system. In this regard, the free falling proppant may hit an impact plate of the impact scale. The horizontal force of this impact generally has a direct relationship to the proppant flowrate and can be used by the system 100 to monitor system 100 performance and/or to control various aspects of system 100 operation. The force may be measured, for example, by a loadcell or a linear variable differential transformer (LVDT), directly connected to the impact plate. Force readings may be integrated with respect to time (e.g., with a computer processor) to provide an integrated proppant flowrate and/or other related data.

The housing 105 of the mechanical conveyor 104 in the drop chute 122 portion has a viewing window 742 that allows viewers to visually inspect the proppant flowing through the drop chute 122 portion of the mechanical conveyor 104. The housing 105 of the mechanical conveyor 104 in the drop chute 122 portion also has a cleaning and inspection panel 744 that can be removed from the housing 105 to provide access into the drop chute 122 portion of the mechanical conveyor 104 for cleaning, inspection, troubleshooting, etc.

A belt cleaner and/or brush 746 is provided underneath and in direct physical contact with the belt 730 of the belt conveyor system just past the top, front end of the belt conveyor system. The belt cleaner and/or brush 746 cleans and/or brushes proppant off of the belt before the belt starts travelling back down the inclined second portion of the belt conveyor system. Any proppant knocked off the belt 730 by the belt cleaner and/or brush 746 falls into the drop chute 122.

The mechanical conveyor 104 also has a dust collection pipe 748 that forms at least part of a dust collection system that collects dust that may be formed from the proppant falling off the upper, front end of the belt 730. The dust collection system can have any one of a wide variety of physical configurations. In one example, the dust collection system comprises a blower, a dust filter, a filter-cleaning system, and a dust receptacle or dust removal system. The blower may be configured to create a pressure differential that causes proppant dust to flow from the space inside the housing 105 just above the top, front end of the belt 730 through the dust collection pipe 748. The dust filter captures any such dust. The filter cleaning system cleans or enables users to remove captured proppant dust from the filter. The dust removal system removes or enables users to remove proppant dust from the dust collection system.

The housing 105 of the mechanical conveyor 104 has clean-out panels/drop out areas 754 at opposite ends of the first section 118 of the mechanical conveyor 104. Each clean-out panel/drop out area 754 is a panel attached to and thereby forming part of the housing 105 on a downward-facing surface thereof. Moreover, each clean-out panels/drop out areas 754 is attached to the rest of the housing 105 in a manner that makes the panel relatively easy to remove from the rest of the housing 105. This enables a user to access the interior of the housing for inspection, cleaning, troubleshooting, etc. In various implementations, other clean-out panels/drop out areas 754 may be provided in other parts of the mechanical conveyor housing including, for example, at the bottom of the drop chute (e.g., at 756 in FIG. 7).

The mechanical conveyor 104 has support legs 758 that extend in a downward direction from a bottom surface of the drop chute 122 portion of the mechanical conveyor. The support legs 758 may be adjustable in length and long enough to reach a surface on which the mechanical conveyor 104 is sitting. The support legs 758 are strong enough to support the drop chute portion 122 of the mechanical conveyor 104 in the configuration shown. The mechanical conveyor 104 has another support leg 760 that extends in a downward direction from the second, inclined portion 120 of the mechanical conveyor. This other support leg 760 may be adjustable in length and is long enough (or can be adjusted to a proper length to be long enough) to reach the surface on which the mechanical conveyor is sitting. This other support leg 760 is likewise strong enough to support the inclined portion 120 of the mechanical conveyor 104 as shown. In various implementations, the mechanical conveyor 104 may have other support legs or other types of support elements.

The mechanical conveyor 104 has lifting lugs 790 that can be grabbed and used to lift and hold up (e.g., during set-up) the inclined portion 120 of the mechanical conveyor 104.

FIG. 8 shows a cross sectional view of the mechanical conveyor 104 at the loading area in the first, horizontal section 118 of the mechanical conveyor.

The cross sectional view shows that the belt 730 is contoured to define a centrally-disposed trough for containing the proppant 862. In this regard, the belt 730 has a flat central portion 864, and two sides 866 that are angled upward from the flat central portion 864. The belt 730 is supported by a central roller 868 that is disposed horizontally, two side rollers 870 that are angled upward from the horizontal central roller 868, and an intermediate slider bed. The slider bed is underneath the conveyor belt. It prevents wear on the bottom and lower sections of the conveyor enclosure. The rollers are supported by brackets. In a typical implementation, this arrangement of rollers and intermediate slider bed is repeated along the length of the belt 730 to provide periodic, typically regular, support for the belt 730.

An upward and outward angled guide 874 is provided as shown above each of the angled side portions of the belt 730. The guides 874 are directly above and very close to (e.g., within a centimeter, within half of a centimeter, within quarter of a centimeter, etc.) the belt 730. In a typical implementation, the guides extend longitudinally along a portion of the belt 730 to help keep the proppant contained toward a center of the belt. The guides 874 help keep the proppant 862 from pouring or moving out to the outer edges of the belt 730. A feed chute 872 (from the proppant storage container 112 of the proppant receiver 102) extends through an opening in the housing of the mechanical conveyor 104 and is sealed to the housing with a spring-loaded inlet seal 877. In some implementations, the seal takes place when the Smart Path is lowered down onto the conveyor. The springs force the seal by pushing up on to the flange of Smart Path knife gates.

The feed chute 872 is configured to drop proppant onto an upper surface of the belt 730 and in a middle portion of the belt (e.g., between the guides 874).

During operation, the proppant 862 atop the belt 730 is carried from the illustrated loading area up to the upper front end of the mechanical conveyor 104, then the belt 730 wraps around the drive pulley and returns to loading area. FIG. 8 shows a first portion of the belt 730 (an endless belt) carrying proppant and a second portion of the belt 730 beneath the first portion returning to the loading area. The second portion of the belt 730 is sliding along a slide plate 871 with guide rails 873 that may be a plastic material (e.g., ultra-high molecular weight polyethylene, UHMW). Hold-down wheels 875 are provided as well. In a typical implementation, the hold down wheels 875 help transition the belt from the horizontal run to the incline angle keeping tension on the belt so the head pully does not slip and/or also spill sand.

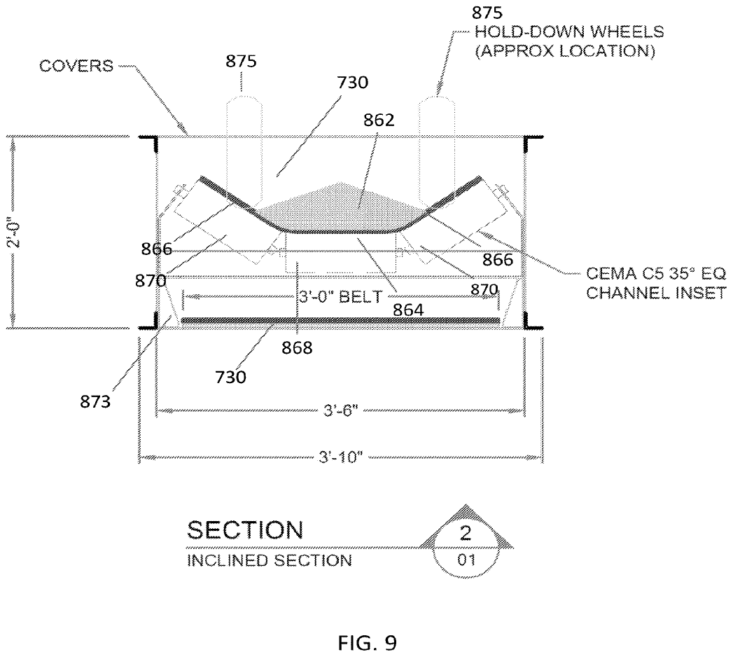

FIG. 9 is a cross sectional view of the mechanical conveyor 104 in the second, inclined section 120 of the mechanical conveyor.

The cross sectional view shows, again, that the belt 730 is contoured to define a centrally-disposed trough for containing the proppant 862. In this regard, the belt 730, again, has a flat central portion 864, and two sides 866 that are angled upward from the flat central portion 864. The belt 730 is supported by a central roller 868 that is disposed horizontally, two side rollers 870 that are angled upward from the horizontal central roller 868, and an intermediate slider bed. The rollers are supported by brackets. Hold-down wheels 875 are provided as well.

A first portion of the belt 730 (an endless belt) is shown carrying proppant up the incline and a second portion of the belt 730 is shown below the first portion returning to the loading area. The second portion of the belt is sliding along a slide plate that may be a plastic material (e.g., ultra-high molecular weight polyethylene, UHMW).

FIG. 10 is a perspective view showing an exemplary implementation of a mechanical conveyor 1004.

The mechanical conveyor 1004 includes a first section 1018 that is horizontal and configured to sit beneath a gravity drop of a proppant storage tank (e.g., 112 in FIG. 1), a second section 1020 that extends at an upward angle from an end of the first section 1018, and the third section 1022 (i.e., the drop chute section) that extends downward from an end of the second section 1020 to a discharge chute 1038 (the blender feed chute) at the distal end of the mechanical conveyor 1004.

The mechanical conveyor 104 has a housing 1005. The housing 1005, in the first section 1018 and the second section 1020 of the mechanical conveyor 1004, contains a belt conveyor system with a conveyor belt having a first horizontal section inside the first section 1018 of the mechanical conveyor housing 1005, and a second inclined section inside the second section 1020 of the mechanical conveyor housing 1005.

During operation, proppant is dropped onto the belt through an opening (not shown in FIG. 10) in the housing 1005 and is carried by the belt on the first, horizontal section of the belt and then up the second, inclined section of the belt. The proppant is then dropped off the upper end of the second, inclined section of the belt into the drop chute 1022 and then to the blender hopper (e.g., screw hopper 1008) through the blender feed chute 1038 portion of the drop chute 1022. The blender feed chute 1038 portion of the drop chute 1022 extends at a downward and frontward angle from the rest of the drop chute 1022. As shown, the blender feed chute 1038 is positioned to extend into the blender hopper 1008 so that the discharge opening (e.g., at the distal end of the blender feed chute 1038) is positioned well below the upper rim of the blender hopper 1008. Typically, as discussed, the discharge opening of the blender feed chute 1038 would be near the inputs of the conveyors (e.g., screw feeders 1080) that convey proppant out of the blender hopper 108 (e.g., and into a blender).

There are three screw feeders 1080 represented in the illustrated implementation. Each screw feeder 1080 has an inclined tube (pipe) that contains a rotating screw for conveying proppant. The three tubes are arranged substantially parallel to one another. Each tube has an inlet at the lower end thereof. In a typical implementation, the blender feed chute 1038 is configured to discharge proppant substantially evenly across all the three inlets. This means, typically, that all three screw feeders 1080 receive a relatively equal and steady flow of proppant from the mechanical conveyor 1004.

A level sensor 1228 is integrated into the drop chute 1022 of the mechanical conveyor 1004 to sense a level of proppant (e.g., inside the drop chute 1022). In such implementations, the level sensor 1228 communicates with a controller and the controller regulates the speed of the belt of the mechanical conveyor 1004 in response to sensor readings from the level sensor 1228. More specifically, in a typical implementation, the controller increases the speed of the belt of the mechanical conveyor 104 in response to sensor reading(s) indicating that the proppant level in the drop chute 1022 has been (or is) low or dropping and/or decreases the speed of the belt mechanical conveyor 1004 in response to sensor reading(s) indicating that the proppant level in the drop chute 122 has been (or is) high or rising. In some implementations, the controller may control the speed of the belt of the mechanical conveyor 1004 so that the speed of the belt of the mechanical conveyor 104 is inversely proportional to the level of proppant sensed by the level sensor 1228.

The housing 1005 of the mechanical conveyor 1004 in the drop chute 1022 portion has a viewing window 1042 (on opposite sides of the drop chute 1022) that allows viewers to visually inspect the proppant flowing through the drop chute 1022 portion of the mechanical conveyor 104. The viewing window 1042 in the illustrated implementation allows viewing into a space of the drop chute 1022 where the level sensor 1228 senses. The housing 1005 of the mechanical conveyor 1004 in the drop chute 122 portion also has a cleaning and inspection panel 1044 that can be removed from the housing 1005 to provide access into the drop chute 1022 portion of the mechanical conveyor 1004 for cleaning, inspection, troubleshooting, etc.

The mechanical conveyor 1004 also has a dust collection pipe 1048 that forms at least part of a dust collection system that collects dust that may be formed from the proppant falling off the upper, front end of the belt. The dust collection system can have any one of a wide variety of physical configurations. In one example, the dust collection system comprises a blower, a dust filter, a filter-cleaning system, and a dust receptacle or dust removal system. The blower may be configured to create a pressure differential that causes proppant dust to flow from the space inside the housing 1005 just above the top, front end of the belt through the dust collection pipe 1048. The dust filter captures any such dust. The filter cleaning system cleans or enables users to remove captured proppant dust from the filter. The dust removal system removes or enables users to remove proppant dust from the dust collection system.

The mechanical conveyor 1004 has support legs 1058 that extend in a downward direction from a bottom surface of the drop chute 1022 portion of the mechanical conveyor. The support legs 1058 may be adjustable in length and long enough to reach a surface on which the mechanical conveyor 1004 is sitting. The support legs 1058 are strong enough to support the drop chute portion 1022 of the mechanical conveyor 1004 in the configuration shown.

The mechanical conveyor 104 has lifting lugs 1090 that can be grabbed and used to lift and hold up (e.g., during set-up) the inclined portion 120, and/or other portions, of the mechanical conveyor 104.

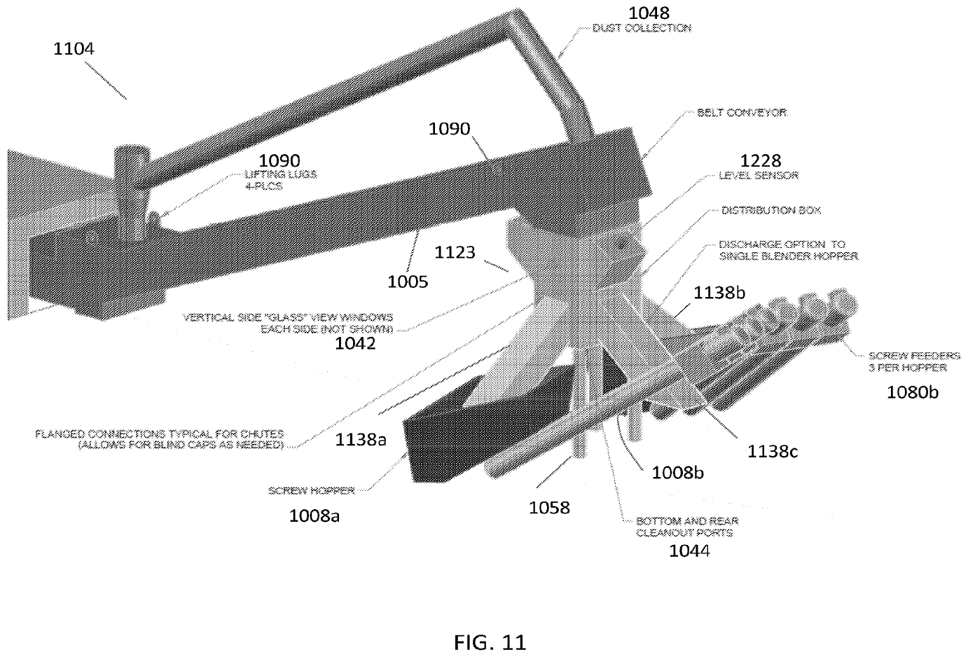

FIG. 11 shows a mechanical conveyor 1104 that is similar to the mechanical conveyor 1004 of FIG. 10 except the mechanical conveyor 1104 is able to feed proppant into multiple (three) different blender hoppers, instead of just one. As such, the physical configuration of the drop chute 1123 in mechanical conveyor 1104 is slightly modified as compared to the drop chute 1022 in mechanical conveyor 1004. More specifically, the drop chute 1123 has three different discharge chutes 1138a, 1138b, 1138c (blender feed chutes), with each blender feed chute 1138a, 1138b, 1138c extending from a different surface of the drop chute 1123 and in a different direction than the others.

For example, blender feed chute 1138a extends downward and outward from a first surface of the drop chute 1123, blender feed chute 1138b extends downward and outward from a second surface of the drop chute 1123, and blender feed chute 1138c extends from downward and outward from a third surface of the drop chute 1123. The first and second surfaces are parallel to one another, and the third surface is perpendicular to the first and second surfaces.

Each blender feed chute 1138a, 1138b, 1138c can be positioned in a different blender hopper. For example, in the illustrated implementation, blender feed chute 1138a is positioned in a first blender hopper 1008a, whereas blender feed chute 1138b is positioned in second blender hopper 1008b, while blender feed chute 1138c could be positioned in a third blender hopper (not shown). In some implementations, each blender feed chute may be provided with a flow restrictor (e.g., a valve) to control flow through the blender feed chute so that flow can be prevented through any of the blender feed chutes that do not have a corresponding blender hopper to feed into.

Each of the two blender hoppers 1008a, 1008b represented in the illustrated implementation has three screw feeders (e.g., screw conveyors) 1080a, 1080b to move proppant out of the blender hopper.

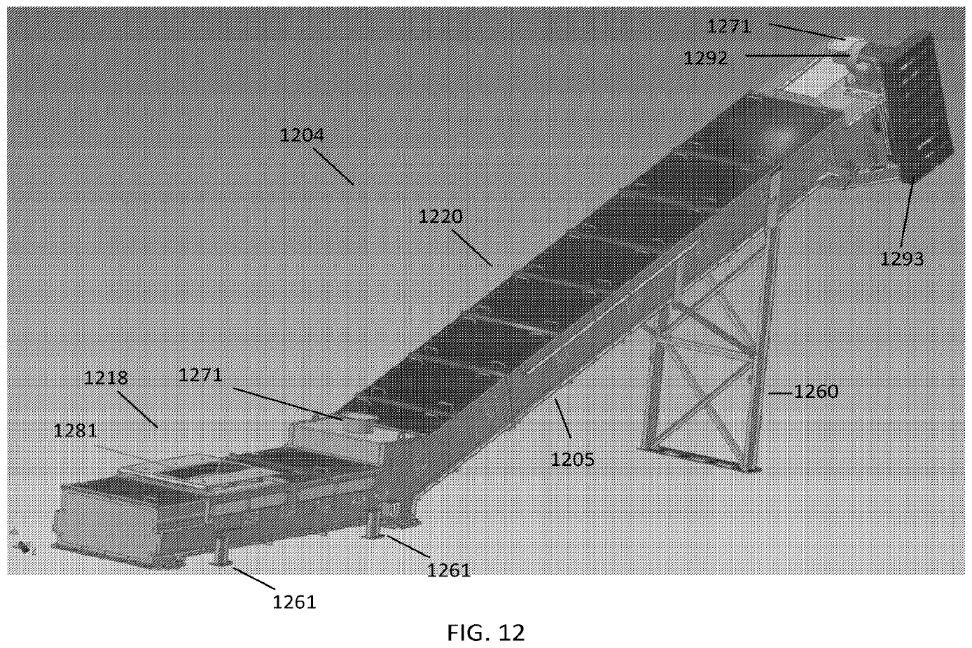

FIG. 12 shows a perspective view of an exemplary implementation of a mechanical conveyor 1204.

The mechanical conveyor 1204 includes the first section 1218 that is horizontal and configured to sit beneath a gravity drop of a proppant storage tank (e.g., 112 in FIG. 1) of a proppant receiver, a second section 1220 that extends at an upward angle (e.g., between 10 degrees and 30 degrees, between 17 degrees and 23 degrees, 17 degrees or 23 degrees from horizontal) from an end of the first section 1218, and a third “drop chute” section (not shown in FIG. 12) that extends downward from an end of the second section 1220 to a discharge chute (a blender feed chute) at the distal end of the mechanical conveyor.

The mechanical conveyor 1204 has a housing 1205. The housing 1205, in the first section 1218 and the second section 1220 of the mechanical conveyor 1204, contains a belt conveyor system consisting of two or more pulleys, with a closed loop of carrying medium (e.g., an endless conveyor belt) that rotates about them. One of the pulleys is powered by electric motor 1292 (via gear box 1293) that moves the belt and the material on the belt forward. The conveyor belt has a first horizontal section that sits inside the first section 1218 of the mechanical conveyor 1204, and a second inclined section that sits inside the second section 1220 of the mechanical conveyor 1204. The mechanical conveyor has support legs 1260 and 1261. The mechanical conveyor has a connection ports 1271 for dust collection. One of the connection ports 1271 is at the top of the inclined section 1220 of the mechanical conveyor 1204, one is at the bottom. The mechanical conveyor 1204 has an opening 1281 in an upper surface of the horizontal portion thereof for delivery of proppant. The mechanical conveyor 1204 removable inspection panels all along its upper surface as shown.

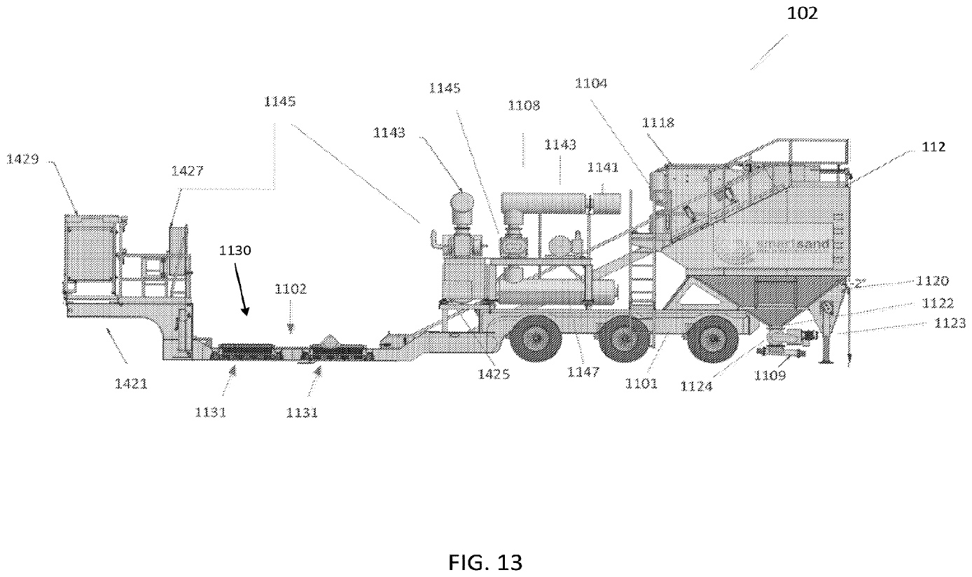

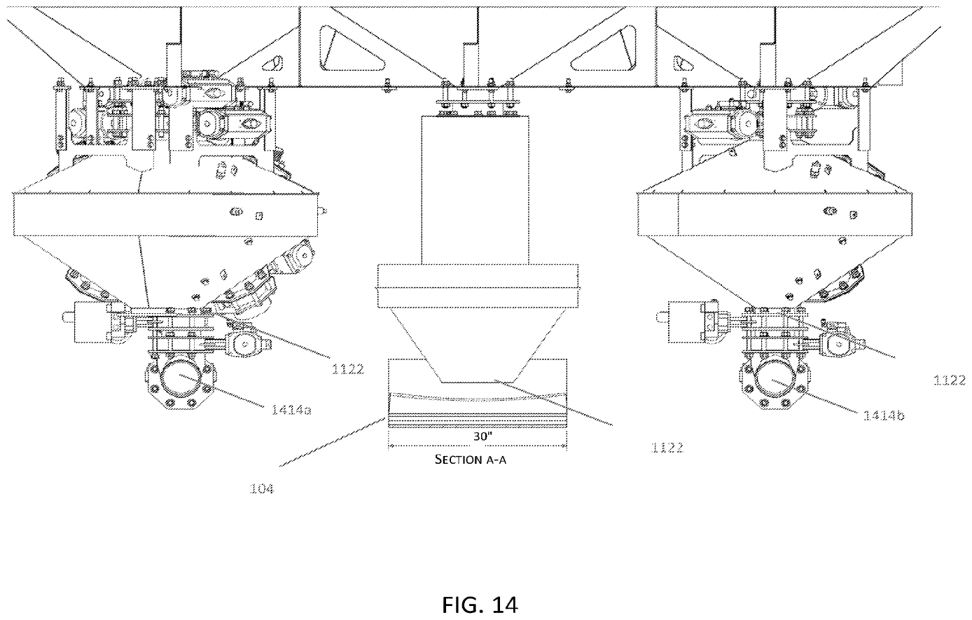

FIGS. 13 and 14 show an exemplary proppant receiver 102 that can be used at a worksite to conveniently transfer proppant, for example, from a gravity feed source (e.g., a truck trailer with gravity dump capabilities, proppant delivery container, etc., not shown in FIG. 13) into a silo, pneumatically, and/or to another storage container onsite (e.g., blender hopper 108) via mechanical conveyor 104.

If the illustrated proppant receiver 102 is available at a particular worksite that has one or more silos, then proppant can be easily conveyed into any of those silos, pneumatically, regardless of how the proppant was delivered to the worksite (i.e., whether the delivery was by pneumatic trailer, by gravity feed trailer, by one of the proppant delivery containers mentioned above, or by some other means). Moreover, the proppant receiver 102 is portable and, therefore, can be moved around a worksite, or from worksite-to-worksite, with relative ease to deliver the proppant into silos. Of course, this portability makes the proppant receiver 102 easy to stow away when not being used as well. The proppant receiver 102 also is relatively simple in design and operation.

At the outset, it should be made clear that FIG. 13 show only one example of how certain aspects of the invention(s) disclosed herein may be implemented. Numerous variations are possible. Indeed, each individual component of the proppant receiver 102 shown in FIG. 13 could be replaced with a different component(s) that performs substantially similarly as the component shown. The arrangement of components also can be varied. In some implementations, the proppant receiver may be an appropriately configured SmartPath™M loading system, available from Smart Sand, Inc., the applicant of the current application.

The illustrated proppant receiver 102 has a chassis 1101 supported on wheels 1105. The front end of the chassis 1101 can be connected to a truck or other vehicle for hauling around as desired or needed. All other proppant receiver 102 components shown in the illustrated implementation are mounted, either directly or indirectly, onto and, therefore, supported by the chassis 1101.

The illustrated proppant receiver 102 has a proppant unloading station 1102, a mechanical conveying system 1104, a proppant storage container 112 (or “surge bin”), and a pneumatic conveying system 1108. The proppant unloading station 1102 is configured so that a bottom dump trailed can be driven over the proppant unloading station 1102 and delivery proppant (e.g., via gravity drop) into the proppant unloading station 1102. The mechanical conveying system 1104 utilizes mechanical components (e.g., a conveyor belt assembly) to convey the proppant from the proppant unloading station 1102 up and into an opening at or near the top of the proppant holding container 112. Belts are absent in the figure, for example, but would follow the angled upward track defined by the belt supports shown. The pneumatic conveying system 1108 uses pneumatic pressure to convey proppant that is released from the bottom of the proppant holding container 112 to a discharge 1109 near a rear of the system 1100. In a typical implementation, a hose or pipe can be attached to the discharge 1109 of the pneumatic conveying system 1108 to carry the discharged proppant to an on-site storage container, such as a silo or the like. An air lock 1124 (or functionally similar structure(s)) is provided to allow the proppant to move from the proppant holding container 112 into the pneumatic conveying system 1108, without compromising the pressure differential between the proppant holding container 112 and the pneumatic conveying system 1108.

The proppant receiver 102 also has capability to gravity drop proppant out of the proppant holding container 112. The gravity drop can be into the opening in the top of the mechanical conveyor 104.

The chassis 1101 in the illustrated system 1100 is a rigid structure and includes high strength, typically metallic, beams that may be welded together to form a structure or frame to support various other system components, as shown. The chassis 1101 is coupled to, and supported by, the wheels 1105 and typically includes provisions for hitching the chassis 1101 to a hauling vehicle. In a typical implementation, one or more rigid plates are provided to form platforms or walls that may be mounted to and supported by the frame structure of the chassis 1100 as well.

The chassis 1100 supports a drive-over ramp assembly 1130. The drive-over ramp assembly 1130 includes four ramp panels 1131—two on each lateral side of the chassis 1100. Each ramp panel 1131 is supported at a proximal end by a hinged connection 1133 along an upper lateral side edge of the chassis 1101 that enables the ramp panel 1131 to move, about the hinged connection 1133, between the deployed position (shown in FIG. 13) and a stowed (or transport) position. In the stowed (or transport) position, the ramp panels 1131 extend in a substantially upward (and slightly inward) direction. In the deployed position (shown in FIG. 13), the ramp panels 1131 extend laterally outward and downward so that their distal ends rest on the ground, thereby forming a ramp, over which a proppant delivery vehicle can drive.

In an exemplary implementation, hydraulic rams provide the energy to move the ramp panels 1131 between the deployed position and the stowed position. Each ramp panel 1131 has two hydraulic rams 1135—one at a forward end of the ramp panel 1131 and one at a rear end of the ramp panel 1131. Each hydraulic ram 1135 has a first end that is secured to and supported by a portion of the chassis that remains stationary as the associated ramp panel 1131 moves up or down, and a second end that is secured to the ramp panel 1131 itself. In the illustrated implementation, the hydraulic rams 1135 extend to raise the ramp panels 1131 and retract to lower the ramp panels 1131.

The ramp panels 1131 are configured to facilitate a proppant delivery vehicle (e.g., truck) driving over them to position its bottom dump opening above the proppant unloading station 1102. More specifically, there is a forward-most ramp panel and a rear-most ramp panel on each side of the chassis. In the deployed position (FIG. 13), the forward-most ramp panel on the left side of the chassis aligns with the forward-most ramp panel on the right side of the chassis, and the rear-most ramp panel on the left side of the chassis aligns with the rear-most ramp panel on the right side of the chassis. Moreover, the forward-most ramp panel on each respective side of the chassis is sufficiently displaced from the rear-most ramp panel on that side of the chassis such that a proppant delivery vehicle (e.g., a delivery truck with bottom dump capabilities) attempting to drive over the ramp panels will have its right side wheels supported by either the forward-most ramp panels or the rear-most ramp panels, and will have its left side wheels supported by the other of the forward-most ramp panels or the rear-most ramp panels.

Panels extend across the top of the chassis 1101 to support the wheels of a proppant delivery vehicle driving over them. These panels, together with the ramp panels 1131, collectively define two tracks to support the wheels of a proppant delivery vehicle driving over the proppant unloading station 1102. The chassis and panels supported by the chassis near the proppant unloading station 1102 define an upward-facing aperture (or opening), covered by a grating, between the two tracks. The aperture is above part of the mechanical conveying system 1104. More specifically, the aperture is above a moving conveyor belt of the mechanical conveying system 1104. As such, if a proppant delivery vehicle drives over the ramp assembly and bottom dumps a delivery of proppant into the aperture and through the grating, the moving conveyor belt can immediately convey the proppant, as it is being unloaded, in a rearward direction away from just under the grating. In a typical implementation, the grating helps prevent large objects (e.g., non-proppant from falling into the mechanical conveying system 1104.

The mechanical conveying system 1104 moves the unloaded proppant away from the proppant unloading station 1102 and to an opening in or near the top of the proppant holding container 112. There are a variety of ways that the mechanical conveying system 1104 can perform this function. In one exemplary implementation, the mechanical conveying system 1104 has one or more moving conveyor belts that convey the proppant in a rearward, horizontal direction away from the proppant unloading station 1102 and then in an upwardly angled direction to the opening in or near the top of the proppant holding container 112. In one such implementation, the mechanical conveying system 1104 has a first section of conveyor belt that extends (and moves proppant) from just under the grating in a rearward direction to a second section of conveyor belt that extends (and moves proppant) from the end of the first section in an upwardly-angled direction to the opening in or near the top of the proppant holding container 112.

In some implementations, the conveyor belt(s) may be curved to define a lateral cross-section with a somewhat concave upper surface to discourage proppant from falling off the sides of the conveyor belt as the proppant is being conveyed. In some implementations, other measures, such as providing separate physical barriers on the sides of the conveyor belt(s), may help prevent the proppant being conveyed from falling off the sides of the conveyor belt(s).

The conveyor belt(s) may be supported and/or directed, by pulleys and/or guide elements. The conveyor belt(s) can be powered in any one of a variety ways. In a typical implementation, one or more of the pulleys for the conveyor belt is driven by prime mover, such as an electric or hydraulic motor or the like.

The upward angle of the upwardly-angled portion of the conveyor belt will depend on the specific geometry of the system 1100. In some implementations, however, the upward angle is between about 10 to 45 degrees (or more preferably between about 20 to 30 degrees) from the longitudinal axis of the chassis 1101. In one exemplary implementation, the upward angle is 28 degrees.

The mechanical conveying system 1104 has a housing 1116 that covers significant portions of the mechanical conveying system 1104. This housing 1116 helps prevent contamination from getting into the and potentially contaminating the proppant, and also helps contain any dust that may be generated by the proppant being conveyed in the mechanical conveying system 1104. The illustrated system 1100 also has a dust collector 1118 coupled to the housing 1116 of the mechanical conveyor system 1104 to help collect dust that is generated from the proppant being conveyed in the mechanical conveying system 1104.

The dust collectors described herein can perform their functions in any one of a variety of ways. In some implementations, a dust collector may be a closed loop dust collection system like the dust collector in the Quickload 300™ transloading system, available from Smart Sand, Inc. In some implementations, the dust collector may be similar to any one of the dust collectors described in U.S. Pat. No. 10,301,108, entitled Silo Dust Collection, and assigned to Quickthree Technology, LLC, the owner of this application. In some implementations, the dust collector creates a low pressure, or vacuum, inside the housing 1116 of the mechanical conveying system 1104. This low pressure, or vacuum, may help draw proppant into the system 1100 through the aperture at the proppant unloading station 1102, thereby helping to contain the escape of dust from the system at the point of unloading.

At the end of the mechanical conveying system 1104, proppant is dropped into an opening at or near the top of the proppant holding container 112. In a typical implementation, the housing 1116 of the mechanical conveying system 1104 seals against the outer surface of the proppant holding container 112 to prevent environmental contamination from entering the system 1100 and to prevent proppant dust from escaping to the environment.

The proppant holding container 112 is a large, hollow, rigid container. In one implementation, the proppant holding container 112 has a storage capacity of approximately 43 tons. In another implementation, the proppant holding container 112 has a storage capacity of approximately 40 tons. The proppant holding container 112 has a lower surface that forms multiple hoppers 1120 with discharge openings (or outlet) 1122 at its bottom. In some implementations, the discharge opening 1122 at the bottom of the hopper 1120 is gated or otherwise controllable (e.g., with a valve or the like) to regulate the flow of proppant out of the proppant holding container 112.

One of the discharge openings 1122 (e.g., the central one, shown schematically in FIG. 14) is configured to dump proppant directly into an opening in the mechanical conveyor 104. The other two 1122 (e.g., the side ones in FIG. 14) are configured to deliver proppant from the proppant holding container 112 into the pneumatic conveying lines (that go to the silos). The pneumatic lines 114, 115 get attached to flanged openings 1414a, and 1414b. Those lines run to corresponding openings on the silos.

Referring again to FIG. 13, the pneumatic conveying system 1108 has multiple air blower assemblies, each of which is configured to provide pressurized air inside the pneumatic conveying system 1108 for conveying proppant that has been released from the proppant holding container 112 to a system pneumatic discharge and beyond. Each air blower assembly may have an intake air filter 1141, which is connected in series to an intake silencer 1143, which is connected in series to a blower 1145, which is connected in series to an outlet silencer 1147. The blowers 1145 are driven by prime movers, which, in the illustrated implementation, are electric motors. More specifically, the pneumatic conveying system 1108 in an exemplary implementation has three such air blower assemblies 1126.

In each air blower assembly, the blower 1145 draws air into the system from the environment through the air filter 1141 and the air intake silencer 1143. The air filter 1141 filters the air entering the system 1100 to help ensure that the air passing into and through the blower 1145 and the system 1100 will be relatively free of contaminants.

The intake air silencer 1143 in each blower assembly helps reduce any air borne noise produced by the blower 1145. If the blower 1145 is a rotary positive displacement blower, for example, as the blower's impeller rotates, air is sucked into the blower, drawing slugs of air into the system at a frequency that depends on the speed and number of lobes in the impellor. The intake air silencer 1143 in this instance may serve to smooth out these slugs of air and reduce the noise emanating from the blower inlet.

The blower 1145 in each blower assembly can be virtually any kind of mechanical component that can move air. In a typical implementation, the blower 1145 is a positive-displacement blower, such as a rotary blower or a reciprocating blower. A rotary-type blower may use internal gears, screws, shuttle blocks, flexible vanes or sliding vanes, circumferential pistons, flexible impellers, helical twisted roots, or liquid-ring pumps, for example, to move the air. A reciprocating-type blower may be a piston pump, plunger pump, or diaphragm pump. Other configurations for the blower 1145 are possible as well.

The outlet silencer 1147 in each blower assembly can serve to reduce pressure pulses and generally smooth out air flow from the blower. If a blower 1145 is a rotary positive displacement blower, for example, the blower 1145 generally discharges air in compressed slugs that can be destructive to equipment downstream of the blower 1145. The outlet silencer 1147 helps reduce these pulsations, and smooth out the resulting air flow.

In various implementations, providing the system with multiple air blower assemblies, as shown, provides a degree of redundancy in the system. Alternatively, in some implementations, more than one of the air blower assemblies may be operated together, simultaneously, to increase the conveying capacity of the pneumatic conveying system 1108. In a typical implementation, the air blower assemblies are connected to the discharge 1109 (which in the illustrated implementation is the distal open end of a pipe) via a network of pneumatic channels, which may include pipes, hoses, and/or valves, for example.

The discharge 1109 can be connected to an external proppant delivery channel (not shown in FIG. 13, but see, e.g., FIGS. 1-6), which may be a pipe, tube, hose, etc. that can carry the proppant to a nearby silo, blender hopper, or some other on-site storage or proppant treatment container. Typically, this external proppant delivery channel would be routed to an inlet at or near the top of the silo, blender hopper, or other container. The inlet to the silo, blender hopper, or other container would usually be significantly higher than the discharge 1109 of the system 1100. Thus, the conveying capacity of system 1100 is high enough to convey the proppant to that higher point.

The proppant holding container 112 discharges proppant from the discharge openings 1122 at the bottom of the hopper 1120. The discharged proppant passes into the pneumatic conveying system 1108 through the air lock 1124. In general, the air lock 1124 can be any mechanical component or combination of mechanical components that allows proppant to flow out of the proppant holding container 112 and into the pneumatic conveying system 1108, without compromising or significantly compromising the pressure differential between the proppant holding container 112 and the pneumatic conveying system 1108.

There are numerous ways to implement the air lock 1124. Some of these are discussed below. However, the discussion below is not exhaustive. Other options are possible and fall within the scope of the current disclosure.

In some implementations, the air lock is a rotary-type air lock. Typically, a rotary-type air lock has a housing that defines an inlet, an outlet, and a rotor housing between the inlet and the outlet. The inlet of the air lock would be connected to the discharge opening of the proppant holding container 112 and the outlet of the air lock would be connected to the pneumatic conveying system 1108. The rotor housing houses a centrally-disposed rotor shaft that can rotate and that supports a plurality of rotor vanes that extend radially outward from the rotor shaft. These rotor vanes are usually regularly spaced around a perimeter of the rotor shaft. Each vane is sized so that its distal end will be very close to, or in contact with, the inner surface of the rotor housing. The rotor shaft may be driven by a small engine or motor (e.g., electric, pneumatic, hydraulic, etc.) or any type of rotational drive. During operation, the engine or motor, for example, turns the rotor shaft, which causes the rotor vanes to rotate thereabout. Granular proppant falls, by gravity, into the inlet, and the rotating rotor vanes move the granular proppant in a downward direction into the pneumatic conveying system 1108 beneath the rotary air lock. At the same time, the close proximity or contact of the vanes to the inner surface of rotor housing help prevent pressurized air from the pneumatic conveying system 1108 from escaping through the rotary air lock and into the proppant holding container 112. Thus, granular proppant is moved from the lower pressure proppant holding container 112 into the higher pressure pneumatic conveying system 1108 without compromising the pressure differential therebetween.

In some implementations, the air lock is a screw-type air lock. One example of a screw-type air lock is a Meyer pneumatic screw pump, available from the Meyer Industrial Solutions company. A pneumatic screw pump is an airlock that uses a screw auger to move the proppant from a gravity feed hopper into a pneumatic conveying system. A pneumatic screw pump typically utilizes the conveyed material itself (e.g., the proppant) to form a seal between the lower pressure proppant holding container and the higher pressure pneumatic conveying system. In some implementations, the pneumatic screw pump may have a gate valve (e.g., a flap-style gate valve downstream of the screw auger) to help prevent blow-back (e.g., the screw pump is being primed and/or when the screw pump runs on empty).

In some implementations, the air lock may include gate lock valves configured, for example, in a manner described in section 3.5 of the Pneumatic Conveying Design Guide, by David Mills, Second Edition. The Pneumatic Conveying Design Guide is hereby incorporated by reference in its entirety herein. An air lock that incorporates gate lock valves typically includes two (or more) gate lock valves that alternately open and close to permit proppant to pass from the proppant holding container to into the pneumatic conveying system. Pressurized air that passes through the lower gate from the pneumatic conveying system may be vented so that it does not interfere with the material about to flow through the upper gate. These gates may be driven in any number of ways including, for example, by motor, cam or air cylinder, or gravity. The gate valves may be virtually any kind of gate valves. One such example is a pneumatic ceramic rotary gate valve, available from Henan Quanshun Flow Control Science & Technology Co., Ltd. Other variations are, of course, possible as well.

In various implementations, the air lock may be configured in any other manner that is disclosed in the Pneumatic Conveying Design Guide, including, for example, those described in section 3.2, entitled “Rotary Valves” of the Pneumatic Conveying Design Guide.

The proppant receiver 102 shown also has an electrical generator set 1429 on a raised platform 1421 near the front end of the chassis 101. The electrical generator set 1429 may be virtually any set of components (e.g., diesel engine with an electrical generator) configured to produce electrical energy that can be used by one or more of the various components (e.g., lights, blowers, controls, etc.) in the proppant receiver (and elsewhere). In some implementations, in fact, the electrical energy produced by the electrical generator set 1429 may be used to power motor(s) for the air blower(s) 1145, motor(s) for the air lock(s), and/or the ramp panels, etc. In a typical implementation, the proppant receiver 102 includes a fuel tank as well. The fuel tank also may be mounted on the raised platform, near or integrated into the electrical generator set 1429. The fuel tank supplies fuel to the internal combustion engines (typically via one or more fuel pumps).

The electrical generator set 1429 feeds the electrical energy it generates to a power distribution panel 1427, which distributes the electrical energy to any electrically-powered components in the proppant receiver 102, etc.

The proppant receiver 102 also has an operator control panel 1425. The operator control panel 1425 can have any one of a variety of different configurations. However, in a typical implementation, the operator control panel 1425 would include all of the controls that a system operator would need access to in order to operate the system 1100. This might include controls for the electrical generator set 1429, controls for the pneumatic conveying system 1108 (including each air blower 1145), controls for the mechanical conveying system 1104, controls for the air lock(s) 1124), etc.

The proppant receiver 102 has jacks 1123 attached to the chassis 1101 and extended in a downward direction. The jacks 1123 can be retracted so that the system 1101 can be moved (e.g., hauled by a hauling vehicle). The jacks 1123 can be extended to lift the system 1101, when the system is intended to remain stationary.

A number of embodiments of the invention have been described. Nevertheless, it will be understood that various modifications may be made without departing from the spirit and scope of the invention.

The proppant can be any kind of proppant. Typically, a proppant is a solid material, typically sand, treated sand or man-made ceramic materials, designed to keep an induced hydraulic fracture open, during or following a fracturing treatment. It may be added to other substances to produce fracking fluid which may vary in composition depending on the type of fracturing used, and can be gel, foam,-based, etc.

In various implementations, the mechanical conveyor 104 may utilize various different types of conveying mechanisms. In the illustrated implementation, the mechanical conveyor 104 utilizes a belt conveyor. In other configurations, however, the mechanical conveyor 104 may utilize other types of mechanical conveying mechanisms, such as screw conveyors, bucket conveyors, etc.

The size, shape, and configuration, relative and absolute, of the system and its various components can vary considerably. Dimensions provided (e.g., in the drawings, etc.) are examples only and can vary at least +/−10% from what is shown. Materials can vary as well.

The system can be implemented with any number (one or more) of silos. The system can be implemented with other types of proppant receivers. The control scheme can vary as well.

As mentioned above, in certain implementations, the proppant unloading system 102 may be the SmartPath™ unloading system, available from Smart Sand, Inc., the applicant of the current patent application. Various aspects of the SmartPath™ unloading system (or “material handling system”), and variations thereof, are described in U.S. Patent Application Publication No. 2022/0017310, entitled Flow Control for Bottom Dump Pneumatic Material Handling, which is attached to this filing and otherwise incorporated by reference herein in its entirety.

In some implementations, one or more of the components described herein as being integrated into one overall assembly, may be physically separate from each other (and not physically integrated). For example, in some implementations, the drive over conveyor may be provided as a separate piece of equipment from the other system components. In those implementations, a mechanical conveyor of the proppant receiver would be provided to mechanically convey material from the drive over conveyor to the separate container. As another example, the blowers may be provided as a separate piece of equipment. In those implementations, the blowers would be connected to the air locks at the bottom of the storage container by pneumatic lines. In general, any system component(s) provided on a separate base (e.g., not mounted on the same chassis as the other system components) would be operationally connected into the system (and to the other system components) as shown in the drawings and otherwise described herein to the other system components. In some implementations, more than one of the system components may be provided as a physically discrete component (and not mounted on the same chassis as the other system components).

Moreover, while this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are disclosed herein as occurring in a particular order, this should not be understood as requiring that such operations be performed in the particular order shown or in sequential order, or that all represented operations be performed, to achieve desirable results.

The systems described herein are material handling system. These systems can be used, of course, to deliver proppant (e.g., sand, treated sand, or man-made ceramic materials) designed to keep an induced hydraulic fractures open, during or following a fracturing treatment, or to deliver any one of various other types of solid materials (e.g., any bulk powder or granular material; sand, grain, cement, powdered chemicals, salt, etc.)

The system is described as being useful at a worksite (e.g., one that includes one or more hydraulic fracturing wellheads). The worksite need not have actual wellheads in place though. Instead, a worksite could be a location where fracking is intended to take place, but where not wellheads are in place yet. The worksite could also be at a temporary storage location. The worksite could also be at a material processing site. The system could work for any bulk powder or granular material; sand, grain, salt, etc.

The system described herein is portable. Portability, however, may be provided for in a variety of other ways than just those explicitly mentioned herein.

Other implementations are within the scope of the claims.

What is claimed is:

1. A system comprising:
a proppant receiving system configured to receive a delivery of proppant from a proppant delivery source and hold the proppant in a proppant storage container;
a blender for utilizing proppant to produce a fracking fluid;
a blender hopper for the blender;
a mechanical conveyor to convey proppant from the proppant storage container to the blender hopper;
a silo adjacent to the blender hopper and configured to deliver proppant into the blender hopper via gravity through a silo discharge chute; and
a pneumatic conveyor to convey proppant from the proppant storage container into the silo.

2. The system of claim 1, wherein the mechanical conveyor comprises:
a first section that extends beneath the proppant storage container and defines an opening through which proppant from the proppant storage container can be dropped onto a conveyor belt;
a second section that is inclined to convey, with the conveyor belt, the proppant to above the blender hopper; and
a third section that accommodates proppant that has fallen off an upper end of the conveyor belt and provides a flow path for the proppant into the blender hopper.

3. The system of claim 2, wherein the third section of the mechanical conveyor comprises a discharge chute with an opening at a distal end thereof.

4. The system of claim 3, wherein the mechanical conveyor discharge chute and the silo discharge chute extend into the blender hopper.

5. The system of claim 4, wherein the mechanical conveyor discharge chute extends into the blender hopper deeper than the silo discharge chute.

6. The system of claim 5, further comprising:
a blender hopper conveyor to convey proppant out of the blender hopper and into the blender.

7. The system of claim 6, wherein an opening at a distal end of the mechanical conveyor discharge chute is closer than an opening at a distal end of the silo discharge chute to the blender hopper conveyor.

8. The system of claim 6, further comprising:
a level sensor to sense a level of proppant in the third section of the mechanical conveyor.

9. The system of claim 8, further comprising:
a controller to control a speed of the mechanical conveyor in response to one or more signals from the level sensor.

10. The system of claim 9, further comprising:
proppant in the blender hopper,
wherein the proppant in the blender hopper is at a sufficiently high level at the silo discharge chute that the proppant chokes off and prevents flow of proppant through the silo discharge chute unless and until the proppant in the blender hopper near the silo discharge chute drops.

11. The system of claim 10, wherein the mechanical conveyor replenishes proppant in the blender hopper as the blender hopper conveyor removes proppant from the blender hopper.

12. The system of claim 11, wherein the blender hopper conveyor comprises multiple screw conveyors, wherein each screw conveyor has an input, and wherein the mechanical conveyor discharge chute is positioned and configured to deliver proppant to each of the inputs.

13. A method comprising:
providing a system according to claim 1; and
utilizing the silos as a backup to the mechanical conveyor.
